(19) United States
(12) Patent Application Publication
(10) Pub. No.: US 2006/0037589 A1
(43) Pub. Date: Feb. 23, 2006

(54) Heat pipe for heating of gasoline for on-board octane segregation

(76) Inventors: Ramesh Gupta, Berkeley Heights, NJ (US); Sanjay K. Bhatia, Manassas Park, VA (US); George P. Walchuk, Annandale, NJ (US); Randall D. Partridge, Califon, NJ (US); Walter Weissman, Basking Ridge, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/187,672

(22) Filed: Jul. 22, 2005

Related U.S. Application Data
(60) Provisional application No. 60/602,218, filed on Aug. 17, 2004.

(51) Int. Cl. F02G 5/00; F02B 13/00

(52) U.S. Cl. 123/557; 123/575

(57) ABSTRACT

In an internal combustion engine fuel system having a membrane separator for separating a primary fuel into a high octane fuel and a low octane fuel, and wherein the primary fuel is heated for separation in the membrane separator, the improvement comprising a heat pipe having an evaporator section positioned to be in the heat exchange relationship with exhaust gas from the internal combustion engine under conditions of use; and a heat output area in heat exchange relationship with a primary fuel as it is fed into the separator whereby the primary fuel is heated. In one embodiment the heat pipe is a variable conductance heat pipe having a top operating temperature not greater than about 160° C.

This application claims the benefit of U.S. Provisional Application No. 60/602,218 filed Aug. 17, 2004.

### FIELD OF THE INVENTION

The present invention relates generally to tailoring the composition of an engine fuel to meet the engine's drive cycle conditions by utilizing exhaust heat from the engine to provide a plurality of fuel components for engine operation. More specifically the invention is concerned with controlling the temperature of a fuel being fed to a separation device incorporated in an internal combustion engine fuel supply system for separation into a plurality of fuel compositions therein.

### BACKGROUND OF THE INVENTION

The on-board separation of gasoline into a high octane and a low octane fraction for injection into an internal combustion engine at different parts of the drive cycle has been the subject of numerous investigations in recent years and various separation devices have been proposed. To facilitate an understanding of the problems associated with such separations, specific reference is made to the use of a membrane separator in an engine fuel supply system to effect the separation. Such a system is disclosed in U.S. Pat. No. 6,622,663, which is incorporated herein by reference.

In the on-board octane segregation, gasoline is heated to 80-160° C., preferably to about 140° C. before it is fed to a membrane module for separation into high-octane and low-octane fractions. Heating the gasoline using the waste heat in the auto exhaust is an energy efficient approach and conventional heat exchangers have been envisioned as accomplishing such heating. Unfortunately space limitations make use of conventional heat exchangers difficult. Also carefully designed control schemes and equipment are required to assure that the heated gasoline does not exceed 160° C. otherwise reactive components in the gasoline, such as diolefins can react and foul the equipment.

Thus one object of the invention is to provide a novel and effective means of controlling the temperature of a gasoline stream to be fed into a separator incorporated in a fuel system of an internal combustion engine.

Another object is to provide means for heating a gasoline stream to be fed into a separator incorporated in the fuel supply system of an internal combustion engine that can be readily configured to meet space and orientation requirements of the system.

### SUMMARY OF THE INVENTION

Accordingly, in an internal combustion engine fuel system having a separator for separating a primary fuel into a high octane fuel and a low octane fuel, and wherein the primary fuel is heated for separation in the separator, the improvement comprising a heat pipe having an evaporator section positioned to be in the heat exchange relationship with exhaust gas from the internal combustion engine under conditions of use; and a heat output area in heat exchange relationship with a primary fuel as it is fed into the separator whereby the primary fuel is heated.

In one embodiment the heat pipe is a variable conductance heat pipe having a top operating temperature not greater than about 160° C.

### BRIEF DESCRIPTION OF DRAWINGS

FIG. 1 is a block diagram showing a fuel system employing a membrane separator for separating a primary fuel into a high octane fuel and a low octane fuel.

FIG. 2 is a block diagram showing the use of a heat pipe in a fuel system such as that shown in FIG. 1.

FIG. 3 is a diagramatic illustration of the arrangement of a heat pipe for use in the system of FIG. 2.

FIG. 4 is a schematic cross section of one arrangement of a heat pipe according to the invention.

### DETAILED DESCRIPTION OF THE INVENTION

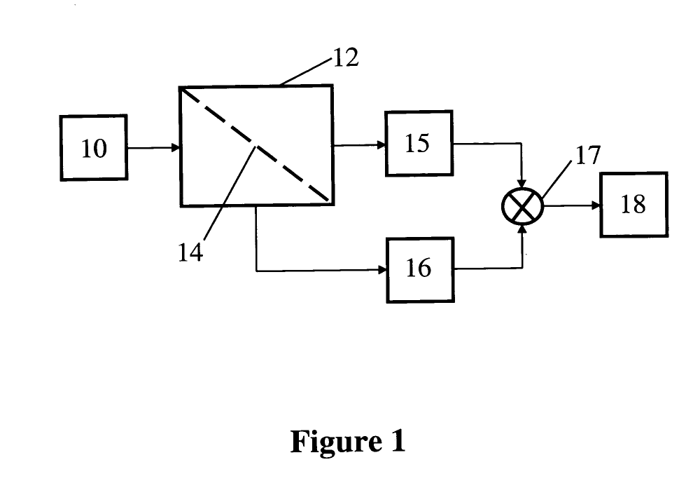

The present invention is particularly suitable for use with a fuel system such as that claimed in U.S. Pat. No. 6,622,663 which is incorporated herein by reference. As can be seen from FIG. 1 herein, such a system includes a fuel tank 10, which serves as the primary fuel supply source. Fuel is supplied from fuel tank 10 to membrane separator 12. The membrane material, illustrated by 14, is chosen to selectively permeate relatively high octane constituents of gasoline. The permeate constituents segregated by the membrane apparatus 12 are supplied to a high octane fuel accumulator 15 while the retentate is supplied to a low octane fuel accumulator 16. An admix controller (not shown) selectively operates a mixing valve 17 to deliver fuel from the low octane accumulator, the high octane accumulator or a mixture thereof to engine 18 for combustion therein.

In the present invention hot exhaust gases from engine 18 are used to heat the primary fuel supplied to separator 12. This heating is accomplished by means of a heat pipe. As is known a heat pipe comprises a closed, evacuated chamber that contains a thermodynamic working fluid. In operation the working fluid absorbs its latent heat of vaporization in an evaporation section of the pipe and moves the heat to a heat output area where condensation takes place. Condensate returns to the evaporation section by gravity. Alternatively a wick also can be used to return the condensate by capillary forces such as when the heat pipe is oriented substantially horizontally and gravitational forces would not effect return of condensate to the evaporation section.

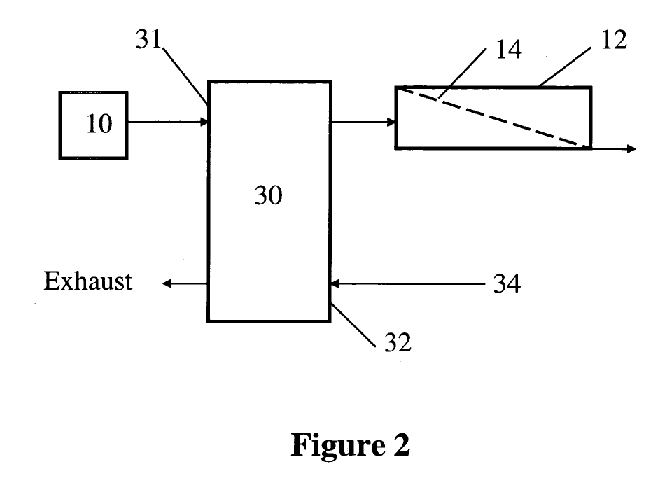

Thus in the present invention the heat pipe is positioned to have an evaporation section in communication with exhaust gas to transfer heat to the working fluid causing it to be vaporized and flow to the condensation section of the heat pipe. The condensation section of the heat pipe is positioned in heat transfer communication with the primary fuel being fed to the membrane separator. This is shown in FIG. 2 in which fuel from fuel tank 10 is fed in heat exchange relationship with the heat output area 31 of heat pipe 30 prior to being segregated in separator 12 and engine exhaust gas stream 34 supplies heat to the evaporator section 32 of heat pipe 30.

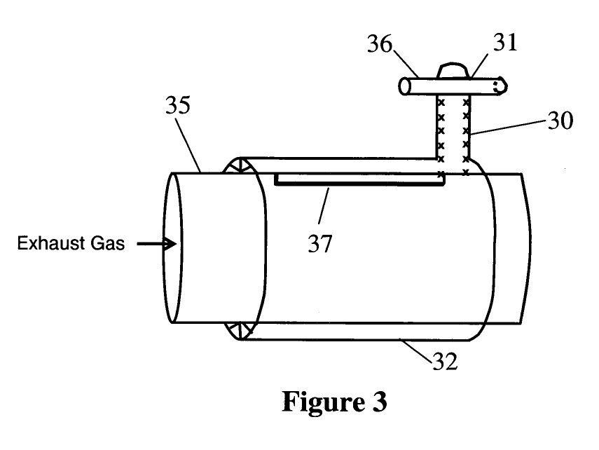

In one embodiment of the invention shown in FIG. 3, the evaporator section 32 of heat pipe 30 is arranged around the periphery of a tubular exhaust gas conduit 35. The heat output area 31 is in heat exchange relationship with supply line 36 through which fuel from tank 10 flows and is heated. To facilitate the heat collection from the exhaust gas stream to the vaporizer section 32 of heat pipe 30 a plurality of heat exchange fins 37 are provided. As shown the fins 37 extend preferably for the entire length of section 32. These fins 37 may be mounted on the exhaust gas conduit 35 along the length of the vaporizer section 32.

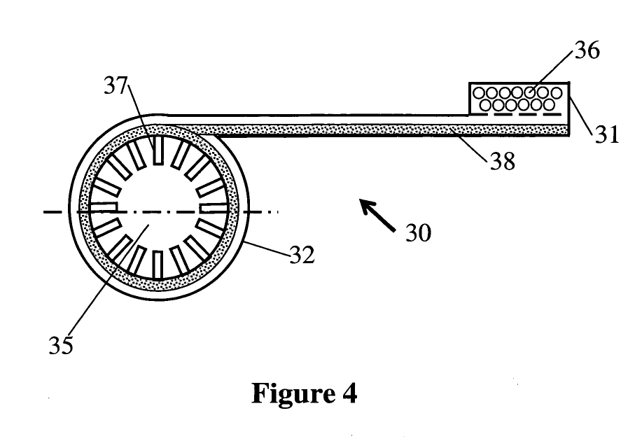

One embodiment of a suitable heat pipe configuration is shown in a cross section in FIG. 4. In this embodiment fins 37 are mounted on the inside wall of the tubular section 35 of the exhaust pipe. The fins 37 are in thermal contact with the exhaust gas. The number of fins are sufficient to provide the heat required to vaporize the heat transfer fluid. As shown heat pipe 30 is provided with a wick material 38 which facilitates the flow of fluid condensate from heat output area 31 to the evaporator section 32. In this embodiment a plurality of supply conduits 36 pass through the heat output section 31 of heat pipe 30 for heating the fluid fed therethrough.

As will be appreciated the heat pipe preferably is one which will limit the temperature of the stream being heated to a value below a threshold. Such heat pipes are referred to as variable conductance heat pipes. Such variable conductance can be achieved for example by selection of an appropriate working fluid. In the practice of the present invention water is the preferred working fluid for heating gasoline to the 140° C. to 160° C. range. Hence, when total vaporization of the water occurs heat transfer in the evaporation section essentially stops and the fuel is not heated above about 160° C. An alternate method is to add a non-condensable inert gas with a working fluid. Of course water-glycol and similar mixtures may be used especially where freezing of the working fluid may be of concern. The wick structure itself may be used to prevent problems associated with freezing. Water frozen inside a wick will exist in small crystals and not cause the mechanical stressed from freezing that can cause the heat pipe to burst when frozen.

Among the advantages of the present invention is that the gasoline feed temperature can be automatically regulated without the need for external controls, valving and the like. The heat will be provided by waste heat, and use of the heat pipe permits various configurations that can be accommodated in the limited spaces on board a vehicle.

Although the present invention has been described with particular reference to a membrane separator other separators may be used. Thus heat may be supplied to effect separation of fuel by distillation. In another embodiment an adsorption type separator may be employed and heat may be supplied in accordance with the invention to desorb from the adsorbent.

What is claimed is:

1. A fuel system for supplying a plurality of fuels for use in an internal combustion engine having a fuel supply comprising:
a fuel supply;
separation means for separating fuel fed to the separation means from the fuel supply into at least a high octane fuel and a low octane fuel;
an engine exhaust stream conduit;
a heat pipe having an evaporator section in thermal communication with the exhaust stream conduit and a heat output section in thermal communication with fuel fed to the separation means whereby the said fuel is heated for separation therein.

2. The system of claim 1 wherein the heat pipe is a variable conductance heat pipe.

3. The system of claim 2 wherein the separation means is a membrane.

4. The system of claim 3 wherein the heat pipe is capable of heating the fuel to a temperature of about 140° C. to about 160° C.

5. The system of claim 2 or 3 wherein the exhaust stream conduit is tubular and the evaporator section of the heat pipe is arranged around the periphery of a portion of said conduit.

6. The system of claim 5 including a plurality of fins in thermal contact between the exhaust conduit and the evaporator section of the heat pipe.

7. The system of claim 6 including a plurality of conduits in thermal communication with the heat output section of said heat pipe through which fuel is fed to the membrane.

8. In an internal combustion engine fuel system having a separator means for separating a primary fuel into a high octane fuel and a low octane fuel and where the primary fuel is heated for separation in the separator, the improvement comprising:
a heat pipe having an evaporator section positioned to be in the heat exchange relationship with exhaust gas from the internal combustion engine under conditions of use and a heat output area in heat exchange relationship with a primary fuel as it is fed into the separator.

9. The improvement of claim 8 wherein the heat pipe is a variable conductance heat pipe operable in the range of about 140° C. to about 160°.

10. The improvement of claim 9 wherein the separator means is a membrane.

11. A method for heating a primary fuel for separation into at least a high octane fuel and a low octane fuel in a separator means comprising:
passing a heated gas stream in thermal communication with an evaporator section of a heat pipe whereby liquid in said section is vaporized and moves to the heat out put section of the heat pipe; and
passing a primary fuel in thermal communication with the heat output section of the heat pipe whereby the fuel is heated and the vaporized liquid in the heat pipe condenser and moves to the vaporizer section.

12. The method of claim 11 wherein the heat pipe is a variable conductance heat pipe having a top operating temperature not greater than about 160° C.

13. The method of claim 12 wherein the separator means is a membrane.
